(19) United States
(12) Patent Application Publication
(10) Pub. No.: US 2021/0034078 A1
(43) Pub. Date: Feb. 4, 2021

(54) DYNAMIC GENERATION OF RESTRICTED FLIGHT ZONES FOR DRONES

(71) Applicant: INTEL CORPORATION, Santa Clara, CA (US)

(72) Inventors: David GOMEZ GUTIERREZ, Tlaquepaque (MX); Jose PARRA VILCHIS, Guadalajara (MX); Rafael DE LA GUARDIA GONZALEZ, Guadalajara (MX); Rodrigo ALDANA LOPEZ, Zapopan (MX); Leobardo CAMPOS MACIAS, Guadalajara (MX)

(73) Assignee: Intel Corporation, Santa Clara, CA (US)

(21) Appl. No.: 16/647,328

(22) PCT Filed: Dec. 27, 2017
(86) PCT No.: PCT/US2017/068588

§ 371 Date: Mar. 13, 2020

(51) Int. Cl. G05D 1/10; B64C 39/02; B64D 45/00; G08G 5/00

(52) U.S. Cl. CPC G05D 1/1064; B64C 39/024; B64C 2201/141; G08G 5/0021; G08G 5/0069; B64D 45/00

(57) ABSTRACT

A drone controller comprises processing circuitry to, at a first time when the drone is in flight, to determine a drone state comprising a position and a velocity of the drone and determine a relative obstacle state comprising a relative position and a relative velocity of the drone with respect to an obstacle. The processor then determines a reaction to avoid the obstacle based on the relative obstacle state and applies a signal related to the reaction to one or more actuator control inputs of the drone that modifies a drone path existing at the first time to avoid the obstacle.

### TECHNICAL FIELD

Embodiments described herein generally relate to systems and methods for the dynamic generation of restricted flight zones for drones.

### BACKGROUND

Drones have proliferated in recent years due to advances in manufacturing and technology, and with this proliferation comes the need for better control to ensure safe operation. Geo-fencing is a technique that may be used to restrict the operational space of autonomous vehicles such as drones. In a typical implementation, the user of a drone defines a path that is a series of waypoints which can be connected by straight lines. The drone then uses its internal global positioning system (UPS) sensors to determine its position and ensure that it will not fly across “virtual fences” defined by boundaries associated with the path.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a pictorial illustration of dynamic fencing and a user's field-of-view, according to an implementation;

FIG. 2 is a pictorial illustration of dynamic fencing and two drones' fields-of-view, according to an implementation;

FIG. 3 is a block diagram illustrating an example of a controller that may be used to control the drone, according to an implementation;

FIG. 4 is a flowchart illustrating an example process by which the controller may operate, according to an implementation;

FIG. 5 is a pictorial diagram that illustrates the reaction vectors that are generated for various agents moving in a scenario, according to an implementation;

FIG. 6 is a pictorial illustration of the field of view of the pilot, according to an implementation;

FIG. 7 is an aerial view of a crowd of people comprising a plurality of individuals, according to an implementation;

FIGS. 8A-8C are pictorial images that help illustrate information needed to properly construct the obstacle positions, showing field of view angles α, β, and known height H (measured or otherwise provided from sensors) from the drone to the center of the image, according to an implementation;

FIG. 9, which is a perspective view of the scene illustrated in FIG. 7—as the drone files along its path, according to an implementation;

FIG. 10, which is a pictorial diagram illustrating the repulsive and attractive force boundaries, according to an implementation; and

FIG. 11 is a block diagram illustrating a machine in the example form of a computer system, within which a set or sequence of instructions may be executed, according to an implementation.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

The following acronyms and definitions are provided for the discussion below:

| | |
|---|---|
| boundary(ies) | (or geofence) a 2D surface(s) that bounds |
| | an obstacle (multiple surfaces may be |
| | necessary for bounding non-contiguous |
| | obstacles) |
| FOV | field-of-view |
| object | a physical entity located in 3D space |
| obstacle | a 3D contiguous or non-contiguous region |
| | of space that is not to be entered by the |
| | drone; this may or may not be associated |
| | with an object |
| path | a planned drone trajectory |
| subject | a 3D region of space to be imaged that may |
| | or may not be associated with an object |

The use of virtual fences with drone technology is a convenient way to control a flight path of the drone. In some situations, it may be advantageous if virtual fences are automatically generated by a drone or by a group of drones based on their mission and on information gathered from onboard sensors, such as radar, cameras, etc., and external sensors such as beacons. A few examples of situations where virtual fences may be useful are: (1) multiple drones flying in close proximity to each other that require a protected space around them; (2) government regulations in countries such as the United States requiring that drones remain inside a field of view of the pilot at all times and avoid flying over groups of people; and (3) camera drones that are capturing a same scene as other camera drones (in which case such camera drones should try to avoid entering inside the camera FOV of another drone). Described below are examples of systems, devices, algorithms, and methods for dynamically generating restricted flight zones for drones, as well as their application to the above problems.

The FIGS. below illustrate certain aspects in 2D form—however, one of skill in the art would understand how the illustrations may be properly extended into 3D space.

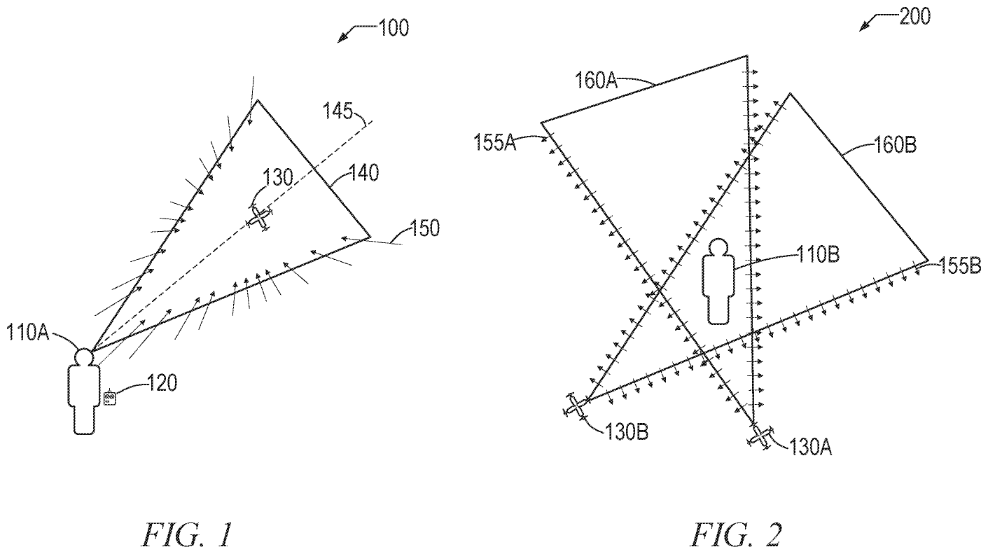

FIGS. 1 and 2 illustrate two different problems that are considered herein. FIG. 1 is a pictorial illustration of dynamic fencing and a user's field-of-view. In the illustrated example of a dynamic fencing arrangement 100 of FIG. 1, a user person 110A (operator) operates a drone control 120 associated with a drone 130. In FIG. 1, a current FOV boundary 140 representing an FOV of the operator 110A exists at a particular time. However, due to a constraint or requirement, such as United States (US) Regulations requiring that the drone 130 remain within the operator's 110A FOV boundary 140 at all times, the current boundary within which the drone must remain is represented by the operator's FOV boundaries 140 which may constantly change. Since this is a containment boundary 140, the illustrated vectors 150 point inward and indicate a desire to drive the drone 130 away from the boundary 140 in an inward direction. As illustrated in FIG. 1, the field of view boundary 140 is a triangle, but in 3D space, this may be represented by a cone, and have at its center a line representing the user's line of sight or viewing direction 145.

In one implementation, this line representing the viewing direction 145 may be approximated by presuming that the operator 110A is looking in the direction of the drone 130, and thus determined based on the operator's 110A location (or possibly the operator's 110A head location) and a current position of the drone 130. In another implementation, image recognition utilizing information from the drone's camera or other sensor may be utilized to determine an actual direction that the drone operator 110A is looking to determine the line 145 representing the viewing direction.

FIG. 2 is a pictorial illustration of dynamic fencing and two drones' fields-of-view. In the illustrated example of a dynamic fencing arrangement 200 of FIG. 2, a subject person 110B is within respective field of view boundaries 160A, 160B of two drones 130A, 130B, respectively, in a multi-camera video capture operation. In this arrangement 200, it is desirable to have each drone 130A, 130B simultaneously capturing video or images of the subject person 110B from their own respective vantage points, but without entering into the other's FOV boundary 160A, 160B. Thus, the boundaries represented by the drone FOV boundaries 160A, 160B for each of the drones 130A, 130B represent boundaries for avoidance. In other words, the FOV boundary 160A of the first drone 130A is a boundary that should be avoided by the second drone 130B, and vice versa. Since these are avoidance boundaries 160A, 160B, the illustrated vectors (repulsive forces) 155A, 155B point outward and indicate a desire to drive another drone 130A, 130B away from the boundary 160A, 160B in an outward direction, so that, for example, drone 130A is repulsed from boundary 160B of drone 130B. As illustrated in FIG. 2, these FOV boundaries 160 are triangles, but in 3D space, these may be represented by cones.

For the sake of convenience, as discussed herein, boundaries may be indicated as attractive (e.g., inward forces 150, as shown in FIG. 1), or repulsive (e.g., outward forces 155, as shown in FIG. 2). However, these are arbitrary distinctions and depend on the particular volume being considered. For example, in FIG. 1, the conical boundary 140 defining a user's 110A field of view is an attractive boundary if the conical shape region is considered the bounding volume. However, if the region outside of the cone 140 is the volume under consideration, then the forces 150 could be considered repulsive. Put more simply, “attractive” forces push into the cone, and these same forces considered as “repulsive” forces push away from the “outside of the cone” region. This distinction is only for ease of discussion, and the mathematical operations related thereto can resolve this easily.

Static geo-fencing and path planning methods are methods that may be used to solve the problems described above however, both of these solutions require prior knowledge of restricted flight zones, which are either static or change slowly relative to an intended mission. The mission planner, e.g., the pilot or some type of centralized planning system, defines the boundaries and goals of the mission so that a lower level planner may generate conflict-free trajectories for all agents involved. Existing solutions for static geo-fencing involve the user to manually defining the boundaries for the drone. However, this approach is not possible to do when the boundaries are dynamically defined based on the states of various agents (drones, cameras, subjects, obstacles, zones), as in the case of using multiple drones 130A, 130B with cameras or flying a drone 130 (reference numbers may have character suffixes omitted herein when referring to multiple elements collectively, or one element representatively) over changing groups of people.

Online planning algorithms may be used to generate collision-free trajectories around static and even some dynamic obstacles. However, when multiple agents are involved, as in the multi-drone with camera problem, planning for multiple agents is computationally intensive and may be difficult to do online.

Described herein are possible solutions which may provide drones 130 with a fast reaction capability for avoiding close moving obstacles. Some solutions may enable coexistence with multiple agents even if not all of them apply the same or similar collision avoidance algorithms. Moreover, various algorithms may be modified to enable an automatic creation of restricted flight zones which may depend on the dynamic characteristics of one or multiple interacting agents.

The solutions discussed herein may be embedded in a flight controller of the drones 130, enabling low-level compliance with safety regulations and new multi-drone applications via the creation of dynamically generated restricted flight zones. This approach may be used to supplement and simplify the tasks of higher-level planners, especially in multi-drone applications, by automatically managing collision-prevention with obstacles as well as restrictions imposed by the dynamic boundaries defined by the application.

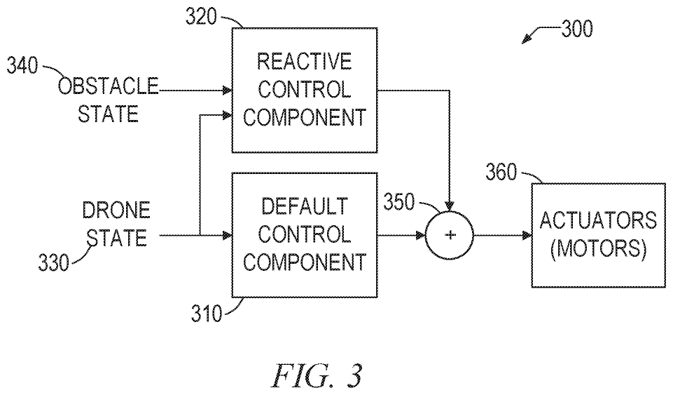

FIG. 3 is a block diagram illustrating an example of a controller 300 that may be used to control the drone 130. The controller 300 may comprise a default control component 310 that operates in a conventional manner to receive input commands and translate them into signals that are provided to actuators (motors) 360 that may be attached to control surfaces, engine controls, and other physical control elements of the drone 130. The default control component 310 may include trajectory tracking or stabilization components.

As shown in FIG. 3, the controller 300 may also comprise a reactive control component 320 that may be added to the default control component 310 and that may perform calculations related to the environment in which the drone 130 is located.

The reactive control component 320 (and the default control component 310) may have a drone state 330 as an input that includes the drone's 130 location, orientation, velocity, etc. The reactive control component 320 may also have the drone state 330 as an input as well as an obstacle state 340 that may include forbidden zones (which may include a position and a velocity of a nearest point for the obstacle/forbidden zone). Although the obstacle state 340 is described as a region to be avoided, a dynamic environment state with regions to be favored as well as, or in place of, regions to be avoided may be utilized in some implementations as well. The drone state 330 and obstacle state 340 may be obtained by localization (e.g., GPS and other forms of determining position and orientation), and may include vision algorithms with feature recognition algorithms.

The outputs of the default control component 310 and the reactive control component 320 may be combined 350 with the combined output being fed to the actuators 360.

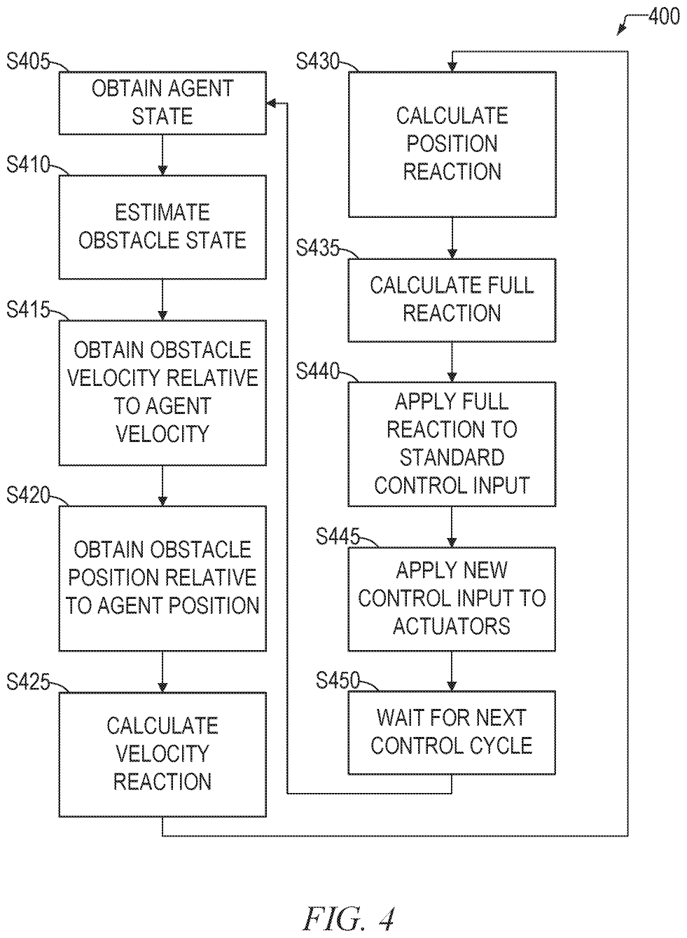

FIG. 4 is a flowchart illustrating an example process 400 by which the controller 300 may operate. In one implementation, the elements of the example process 400 are made to be performed at one point in time or at least within a control cycle, and while the drone is in flight. In the flowchart, letters in bold represent vectors in the tri-dimensional space. In operation S405, the agent (such as the drone 130) state 330 is obtained (location r_{A} and velocity v_{A}). In operation S410, the obstacle state 340 (location r_{O} and velocity v_{O}) are estimated, based on, for example, image processing algorithms that locate features of one or more obstacles, locations of known and recognized features of the surroundings, etc.

In operations S415 and S420, the relative velocity and position between the agent 130 and obstacle are calculated by taking the difference between the previously determined position and velocity components.

The reaction may be separated into two parts: a velocity reaction U_{V} (scalar) and a position reaction U_{R} (vector). The position reaction may take into account the distance and direction to the nearest point in the obstacle, which can be virtually modified in order to add a safe region between the agent and the obstacle. It may be determined, as shown in operation S430, by:

$${U}_{R} = \frac{{r}_{R}}{{‖ {r}_{R} ‖}^{2}}$$

The position reaction U_{R} (as a vector) points in an opposite direction towards the obstacle, thereby moving the agent 130 away from it. The magnitude of this reaction may increase inversely proportional to the distance to the obstacle, i.e., there is a greater position reaction U_{R} when closer to the obstacle. The order of calculating the velocity reaction S425 and the position reaction S430 is not important and these can be sequenced differently in different implementations.

In operation S425, the velocity reaction may be calculated by:

U_{V}=e^{-λv}^{_{R}}^{·r}^{_{R}}.

where
λ=a constant that can be set based on a desired degree of responsiveness.

The velocity reaction U_{V} may serve to diminish the magnitude of the position reaction U_{R} such that obstacles moving towards the agent 130 generate a bigger reaction than an obstacle moving away from the agent 130. In operation S435, the full reaction U is calculated by combining both the position and velocity reactions, where U=−U_{R}U_{V}. In operation S440, this full reaction may be added to the standard control input (at 350), which, in operation S445, is ultimately provided to the actuators 360 of the agent 130. Thus, the end the vector of reactions U (uₓ,u_{y},u_{z}) may then be converted in commands for the roll, pitch, yaw, and thrust. This reaction control thereby allows the agent 130 to move in scenarios with various obstacles and possibly other agents), when all reactions are added together. At operation S450, the process 400 returns to S405 to wait for the next control cycle.

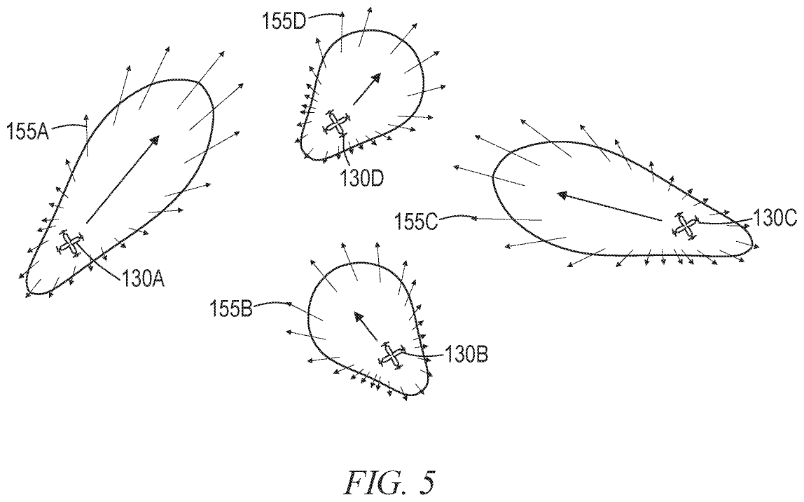

FIG. 5 is a pictorial diagram that illustrates the reaction vectors 155A, 155B, 155C, 155D that are generated for various agents (e.g., drones 130A, 103B, 130C, 130D) moving in a scenario. In this scenario, the agents 130 move towards their goal (included in the default control component) while avoiding collision with the other agents 130 in a self-organizing fashion, in this case, the state of the obstacles (agents) can be obtained by communications related to obstacle positions, by vision/image recognition techniques, or by other techniques. Some of the drones 130A, 130C have reactions U of a greater magnitude than other drones 130B, 130D.

In the US, Federal Aviation Administration (FAA) regulations require that whenever a person wants to fly a drone 130, the drone 130 always needs to be in the field-of-view (FOV) of the pilot, except when waivers are in place. The reactive collision avoidance technique described herein may be applied to ensure compliance of this requirement.

In this situation (and referring to FIG. 1), a virtual fence as a containment boundary 140 may be created around a cone delimiting the pilot's 110A FOV. Attractive force vectors 150 acting at every point on the boundary 140 of the cone prevents the drone 130 from escaping outside the pilot's 110A FOV. The same method can also be used to gently push the drone towards a centerline 145 of the FOV in order to help the pilot 110A to recover sight of the drone 130, for example when the sun is behind the drone 130.

The difference of this situation with respect to general collision avoidance is that the nearest point from the drone 130 to the forbidden zone (here the boundary of the field of view) is not known beforehand. For such a purpose, the following calculation may be used. In this use case, the state of the agent r_{A} is needed as well as the position of the pilot r_{P} with respect to the same frame of reference (here, the position of the pilot may be defined as an origin for the same frame of reference).

The pose of the pilot's head may also be provided to estimate the field of view (although in one implementation, it may be presumed that the pilot is facing the direction of the drone 130). These quantities may be easy to obtain: the pilot's remote control 120 may be equipped with sensors in order to measure the orientation, distance to the drone 130, and direction towards the drone 130. If the direction of view is represented as a unitary vector \hat{d}, and θ the estimated angle of view of the pilot 110A (which may be an estimation known beforehand), then in order to obtain the coordinates of the nearest point on the boundary of the visual cone to the current position of the agent (i.e., the drone 130), the following may be calculated.

First, a unitary vector between the pilot and the agent may be computed:

$${\hat{r}}_{A} = \frac{{r}_{A} - {r}_{P}}{‖ {r}_{A} - {r}_{P} ‖}$$

The vectors that lie in the boundary of the cone (more specifically, the nearest line in the cone to the agent 130 starting at the pilot 110A) are a linear combination of \hat{r}_{A} and \hat{d} (as long as the agent 130 does not lie in the line formed by \hat{d}, which is not a problem since those points are not in danger of falling outside the cone), then there is at least one point in that line that is a combination of the form:

v_{c}= [symbol] +\hat{r}_{A}

Combining this equation with the elation:

$${v}_{c} \cdot \hat{d} = ‖ {v}_{c} ‖ cos ( \frac{θ}{2} )$$

Then, α is the positive solution of the polynomial:

$$- {sin}^{2} ( \frac{θ}{2} ) {α}^{2} - 2 W {sin}^{2} ( \frac{θ}{2} ) α + ( {cos}^{2} ( \frac{θ}{2} ) - {W}^{2} ) = 0$$

### Where:

W=\hat{r}_{A}·\hat{d}

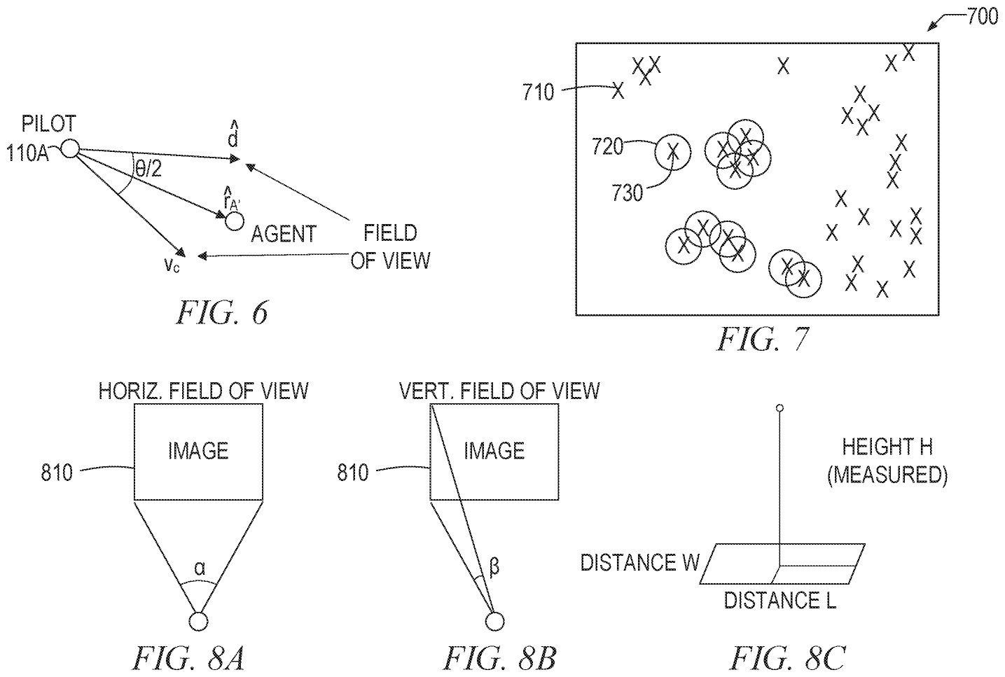

FIG. 6 is a pictorial illustration of the field of view of the pilot 110A with respect to the above calculations. Then, the nearest point to the agent lies in the line

v_{λ}=λv_{c}+r_{P}.
Simple geometric arguments can be used to obtain the nearest v_{λ}* by using

$${λ}^{*} = \frac{{v}_{c}}{‖ {v}_{c} ‖} \cdot ( {r}_{A} - {r}_{P} )$$

Then v_{λ} is used as the “obstacle” coordinates and a repulsive force is calculated.

Another FAA regulation requires that drones 130 must not fly over people. The reactive control component 320 may be used to address this restriction by dynamically placing virtual forces over individuals and over groups of people. For such a purpose, the position of the people needs to be detected using a down facing camera and appropriate people detection and tracking algorithms.

FIG. 7 is an aerial view 700 of a crowd of people comprising a plurality of individuals 710. A person detection algorithm may provide a location of each individual 710 in the image, plus a circle 720 having a radius, which may be a predefined radius and a center at the individual 710 location. The physical distance from the detected targets (individuals) 710 on the ground to the drone 130 can be calculated given the altitude of the drone 130 (which may be determined by any form of altitude measuring device, including GPS), the intrinsic parameters of the camera and the FOV angles. The following figure shows the relevant information that is needed.

FIGS. 8A-8C are pictorial images that help illustrate information needed to properly construct the obstacle positions, showing field of view angles α, β, and known height H (measured or otherwise provided from sensors) from the drone 130 to the center of the image 810.

The equations that allow determining the dimensions of the image 810, considering the available information, may be:

$$tan ( \frac{α}{2} ) = \frac{\frac{L}{2}}{h}$$

$$tan ( \frac{α}{2} ) = \frac{L}{2 h}$$

$$L = 2 h tan ( \frac{α}{2} )$$

Likewise, the width of the image may be calculated as:

$$W = 2 h tan ( \frac{β}{2} )$$

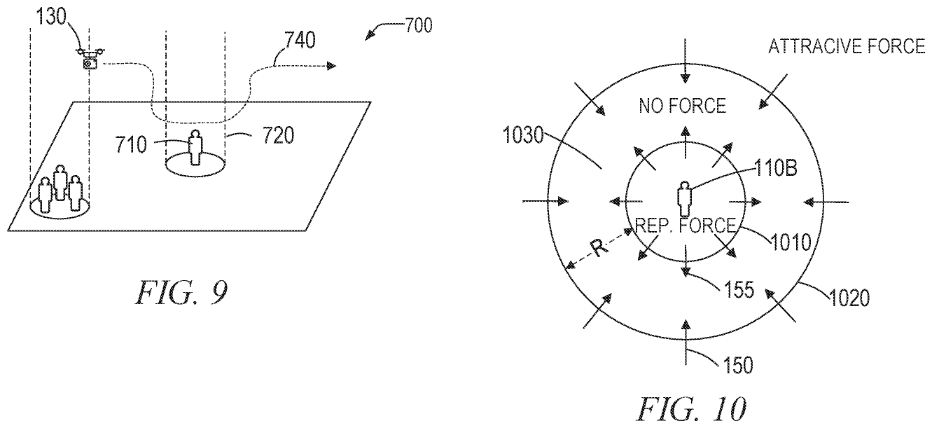

Once the total length L and width W of the image is calculated in meters and in pixels, the position of the people 710 detected can be calculated using the ratio between pixels and meters. Then a reaction force U may be placed on a boundary of the cylinder 720 (extruded from circle in a direction perpendicular to a ground plane) with a radial axis on the person 710 coordinates—see FIG. 9, which is a perspective view of the scene illustrated in FIG. 7—as the drone 130 files along its path 740. In FIG. 9, the extruded circles 720 having a cylindrical shape can be seen. This cylindrical shape represents an obstacle that is to be avoided by the drone 130.

In the situation illustrated in FIG. 2 where multiple drones 130A, 130B are capturing a scene, the cameras of multiple drones 130 record a same target 110B simultaneously from different vantage points (i.e., positions and angles) with the restriction of not flying inside the FOV 160A, 160B of the other drones 130. Therefore, by way of example, in addition to the tracking control that may be used to follow the target 110B, an other drone 130B may broadcast information about its FOV 160 (or about its state, including at least one of position, velocity, and orientation), to the drone 130A (or any other drones 130 within a particular range) so it may avoid disrupting the scene being captured. The above described algorithms can be used to automatically manage interactions between multiple drones by applying repulsive forces 150 on their FOV 160 boundaries, as illustrated in FIG. 2. In one implementation, the information about the other drone 130B may be obtained by analyzing an image taken by the drone 130A, which may include position and orientation (and, with multiple images over time, velocity) of the other drone 130 such that the other drone's 130B FOV can be calculated in a manner similar to that described with respect to FIG. 1. It is also possible that information about the other drone 130B to be used by the drone 130A originate from a device other than the drone 130A or other drone 130B, such as a controller, centralized computer, tracking computer, or other device.

The algorithm may be to place forces on the space as illustrated in FIG. 10, which is a pictorial diagram illustrating the repulsive 1010 and attractive 1020 force boundaries. In addition to the repulsive forces 155 on the repulsive FOV boundaries 1010, a repulsive force boundary 1010 can be placed at a certain distance from the target 110B to ensure that the agent 130 will not collide with it. An attractive force 150 (towards the target 110B) is placed along an attractive force boundary 1020, leaving an empty gap 1030 (of a distance R) between the repulsive 1010 and attractive 1020 boundaries that respectively bound repulsive and attractive space (although R may vary between different portions of the boundaries 1010, 1020, depending on the boundary shapes). The resulting gap/buffer zone 1030 prevents oscillations and allows smooth tracking of the target 110B. The virtual boundaries/geofences around the FOVs for the drones 130 can be calculated in the same way as indicated above.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (CPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, logic or circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

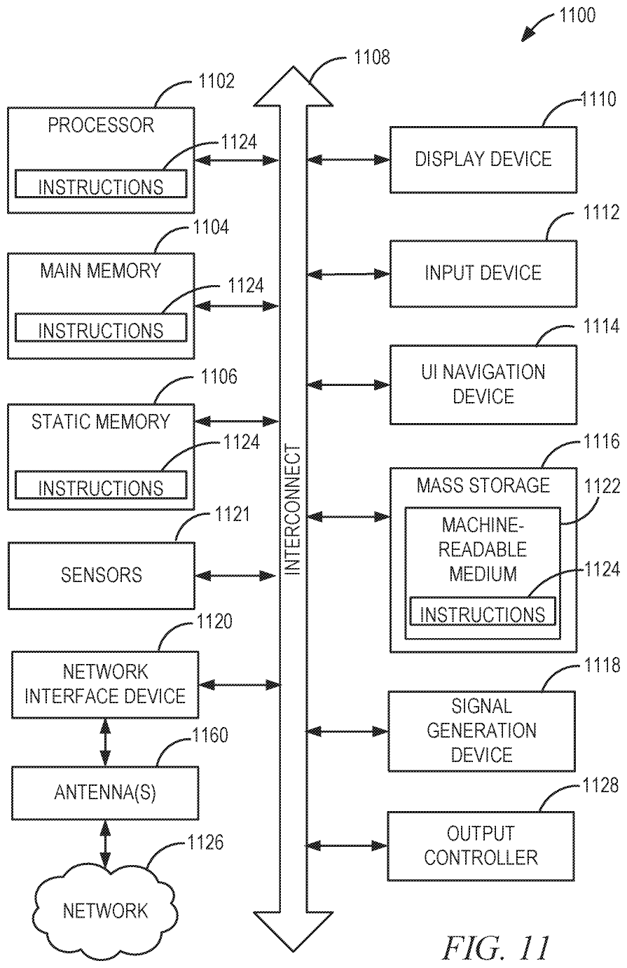

FIG. 11 is a block diagram illustrating a machine in the example form of a computer system 1100, for example, the controller 300, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 1100 includes at least one processor 1102 (e.g., a central processing unit (CPU), a graphics processing unit (GPU) or both, processor cores, compute nodes, etc.), a main memory 1104 and a static memory 1106, which communicate with each other via a link 1108 (e.g., bus). The computer system 1100 may further include a video display unit 1110, an alphanumeric input device 1112 (e.g., a keyboard), and a user interface (UI) navigation device 1114 (e.g., a mouse). In one embodiment, the video display unit 1110, input device 1112 and UI navigation device 1114 are incorporated into a touch screen display. The computer system 1100 may additionally include a storage device 1116 (e.g., a drive unit), a signal generation device 1118 (e.g., a speaker), a network interface device 1120, and one or more sensors (not shown), such as a global positioning system (GPS) sensor, compass, accelerometer, or other sensor.

The storage device 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104, static memory 1106, and/or within the processor 1102 during execution thereof by the computer system 1100, with the main memory 1104, static memory 1106, and the processor 1102 also constituting machine-readable media.

While the machine-readable medium 1122 is illustrated in an example embodiment to be a single medium, the term “machine-readable medium” may include a single medium or multiple media (e.g., a centralized or distributed database, and/or associated caches and servers) that store the one or more instructions 1124. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1124 may further be transmitted or received over a communications network 1126 using a transmission medium via the network interface device 1120 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is drone controller logic at least partially comprising hardware logic to: determine or receive a drone state comprising a position and a velocity of the drone; determine or receive a relative obstacle state, including a relative position and a relative velocity of the drone with respect to an obstacle; determine a reaction to avoid the obstacle based on the relative obstacle state; and apply a signal related to the reaction to one or more actuator control inputs of the drone that modifies a drone path existing at a first time when the drone is in flight to avoid the obstacle.

In Example 2, the subject matter of Example 1 includes, wherein the controller logic is further to define an obstacle boundary as a geofence associated with the obstacle that utilizes information collected at the first time.

In Example 3, the subject matter of Example 2 includes, wherein the obstacle is at least one of: a space outside of a field-of-view (FOV) of an operator of the drone; a space of and over an obstacle object; a space within an FOV of an other drone; a space proximate to an object; and a first space proximate to an object and a second space away from the object that leaves a gap between the first and second space.

In Example 4, the subject matter of Example 3 includes, wherein the controller logic is further to determine the space outside of the drone operator FOV by being operable to: determine a conical space representing the drone operator FOV based on location information of the drone operator and a predefined subtended angle of the conical space from a viewing line.

In Example 5, the subject matter of Example 4 includes, wherein the controller logic is further to determine the viewing line as a line originating from the drone operator location and ending with a location of the drone.

In Example 6, the subject matter of Examples 4-5 includes, wherein the controller logic is further to determine the viewing line as a line along a viewing direction of the drone operator.

In Example 7, the subject matter of Examples 3-6 includes, wherein the controller logic is further to determine the space outside of the drone operator FOV by being operable to: determine a conical space representing the drone operator FOV based on location information of the drone operator and a predefined subtended angle of the conical space from a line originating from the drone operator location and ending with a location of the drone.

In Example 8, the subject matter of Examples 3-7 includes, wherein the controller logic is further to determine the space of and over the obstacle object by being operable to determine a cylindrical space centered on a location of the obstacle person, wherein the cylindrical space has a predefined radius and extends perpendicular to a ground plane.

In Example 9, the subject matter of Examples 3-8 includes, wherein the controller logic is further to determine of the space within the other drone FOV by being operable to determine the space using state information of the other drone.

In Example 10, the subject matter of Example 9 includes, wherein the other drone state information is information received from the other drone.

In Example 11, the subject matter of Examples 9-10 includes, wherein the other drone state information is information received from a source other than the drone and the other drone.

In Example 12, the subject matter of Examples 9-11 includes, wherein the controller logic is further to determine the other drone state information from imaging information taken by a drone camera.

In Example 13, the subject matter of Examples 1-12 includes, wherein the reaction comprises a position reaction component and a velocity reaction component.

In Example 14, the subject matter of Example 13 includes, wherein: the position reaction is determined by:

$${U}_{R} = \frac{{r}_{R}}{{‖ {r}_{R} ‖}^{2}}$$

where
r_{R}=relative location vector between the drone camera and the obstacle; and

the velocity reaction is determined by:

V_{V}=e^{-λv}^{_{R}}^{·r}^{_{R}}

where
r_{R}=relative location vector between the drone camera and the obstacle;
v_{R}=relative velocity vector between the drone camera and the obstacle; and
λ=a constant that can be set based on a desired degree of responsiveness.

In Example 15, the subject matter of Examples 1-14 includes, wherein the controller logic is further to determine the relative obstacle state by being operable to: estimate an obstacle state comprising a relative position and a relative velocity of the obstacle; and determine the relative obstacle state by determining a difference between the drone state and the obstacle state.

In Example 16, the subject matter of Examples 1-15 includes, a drone camera mounted on a drone; and memory coupled to the drone controller logic and the drone camera.

Example 17 is a drone controller apparatus of a drone comprising a drone camera mounted on the drone, the apparatus comprising: memory; and processing circuitry coupled to the memory, the processing circuitry to: at a first time when the drone is in flight, using the processing circuitry of the drone to: determine a drone state comprising a position and a velocity of the drone; determine a relative obstacle state comprising a relative position and a relative velocity of the drone with respect to an obstacle; determine a reaction to avoid the obstacle based on the relative obstacle state; and apply a signal related to the reaction to one or more actuator control inputs of the drone that modifies a drone path existing at the first time to avoid the obstacle.

Example 18 is a method for operating drone controller logic that at least partially comprises hardware logic, the method comprising: determining a drone state comprising a position and a velocity of the drone; determining a relative obstacle state comprising a relative position and a relative velocity of the drone with respect to an obstacle; determining a reaction to avoid the obstacle based on the relative obstacle state; and applying a signal related to the reaction to one or more actuator control inputs of the drone that modifies a drone path existing at a first time when the drone is in flight to avoid the obstacle.

In Example 19, the subject matter of Example 18 includes, defining an obstacle boundary as a geofence associated with the obstacle that utilizes information collected.

In Example 20, the subject matter of Example 19 includes, wherein the obstacle is at least one of: a space outside of a field-of-view (FOV) of an operator of the drone; a space of and over an obstacle object; a space within an FOV of an other drone; a space proximate to an object; and a first space proximate to an object and a second space away from the object that leaves a gap between the first and second space.

In Example 21, the subject matter of Example 20 includes, determining the space outside of the drone operator FOV by: determining a conical space representing the drone operator FOV based on location information of the drone operator and a predefined subtended angle of the conical space from a viewing line.

In Example 22, the subject matter of Example 21 includes, determining the viewing line as a line originating from the drone operator location and ending with a location of the drone.

In Example 23, the subject matter of Examples 21-22 includes, determining the viewing line as a line along a viewing direction of the drone operator.

In Example 24, the subject matter of Examples 20-23 includes, determining the space outside of the drone operator FOV by: determining a conical space representing the drone operator FOV based on location information of the drone operator and a predefined subtended angle of the conical space from a line originating from the drone operator location and ending with a location of the drone.

In Example 25, the subject matter of Examples 20-24 includes, wherein the determining the space of and over the obstacle object is performed by determining a cylindrical space centered on a location of the obstacle person, wherein the cylindrical space has a predefined radius and extends perpendicular to a ground plane.

In Example 26, the subject matter of Examples 20-25 includes, wherein the determining of the space within the other drone FOV is performed by determining the space using state information of the other drone.

In Example 27, the subject matter of Example 26 includes, wherein the other drone state information is received from the other drone.

In Example 28, the subject matter of Examples 26-27 includes, wherein the other drone state information is received from a source other than the drone and the other drone.

In Example 29, the subject matter of Examples 26-28 includes, wherein the other drone state information is determined from imaging information taken by a drone camera.

In Example 30, the subject matter of Examples 18-29 includes, wherein the reaction comprises a position reaction component and a velocity reaction component.

In Example 31, the subject matter of Example 30 includes, wherein: the position reaction is determined by:

$${U}_{R} = \frac{{r}_{R}}{{‖ {r}_{R} ‖}^{2}}$$

where
r_{R}=relative location vector between the drone camera and the obstacle; and

the velocity reaction is determined by:

V_{V}=e^{-λv}^{_{R}}^{·r}^{_{R}}

where
r_{R}=relative location vector between the drone camera and the obstacle;
v_{R}=relative velocity vector between the drone camera and the obstacle; and
λ=a constant that can be set based on a desired degree of responsiveness.

In Example 32, the subject matter of Examples 18-31 includes, wherein determining the relative obstacle state comprises: estimating an obstacle state comprising a relative position and a relative velocity of the obstacle; and determining the relative obstacle state by determining a difference between the drone state and the obstacle state.

Example 33 is a method for operating a drone controller of a drone comprising a drone camera mounted on the drone, the drone controller comprising: at a first time when the drone is in flight, using a processor of the drone to perform operations of determining a drone state comprising a position and a velocity of the drone; determining a relative obstacle state comprising a relative position and a relative velocity of the drone with respect to an obstacle; determining a reaction to avoid the obstacle based on the relative obstacle state; and applying a signal related to the reaction to one or more actuator control inputs of the drone that modifies a drone path existing at the first time to avoid the obstacle.

Example 34 is a computer-readable storage medium that stores instructions for execution by drone controller logic that at least partially comprises hardware logic, the instructions to configure the drone controller logic to cause the wireless device to: determine a drone state comprising a position and a velocity of the drone; determine a relative obstacle state comprising a relative position and a relative velocity of the drone with respect to an obstacle; determine a reaction to avoid the obstacle based on the relative obstacle state; and apply a signal related to the reaction to one or more actuator control inputs of the drone that modifies a drone path existing at a first time when the drone is in flight to avoid the obstacle.

In Example 35, the subject matter of Example 34 includes, instructions for defining an obstacle boundary as a geofence associated with the obstacle that utilizes information collected at the first time.

In Example 36, the subject matter of Example 35 includes, wherein the obstacle is at least one of a space outside of a field-of-view (FOV) of an operator of the drone; a space of and over an obstacle object; a space within an FOV of an other drone; a space proximate to an object; and a first space proximate to an object and a second space away from the object that leaves a gap between the first and second space.

In Example 37, the subject matter of Example 36 includes, instructions for determining the space outside of the drone operator FOV by: determining a conical space representing the drone operator FOV based on location information of the drone operator and a predefined subtended angle of the conical space from a viewing line.

In Example 38, the subject matter of Example 37 includes, instructions for determining the viewing line as a line originating from the drone operator location and ending with a location of the drone.

In Example 39, the subject matter of Examples 37-38 includes, instructions for determining the viewing line as a line along a viewing direction of the drone operator.

In Example 40, the subject matter of Examples 36-39 includes, instructions for determining the space outside of the drone operator FOV by: determining a conical space representing the drone operator FOV based on location information of the drone operator and a predefined subtended angle of the conical space from a line originating from the drone operator location and ending with a location of the drone.

In Example 41, the subject matter of Examples 36-40 includes, wherein the determining the space of and over the obstacle object is performed by instructions for determining a cylindrical space centered on a location of the obstacle person, wherein the cylindrical space has a predefined radius and extends perpendicular to a ground plane.

In Example 42, the subject matter of Examples 36-41 includes, wherein the determining of the space within the other drone FOV is performed by instructions for determining the space using state information of the other drone.

In Example 43, the subject matter of Example 42 includes, wherein the other drone state information is received from the other drone.

In Example 44, the subject matter of Examples 42-43 includes, wherein the other drone state information is received from a source other than the drone and the other drone.

In Example 45, the subject matter of Examples 42-44 includes, wherein the other drone state information is determined from imaging information taken by a drone camera.

In Example 46, the subject matter of Examples 34-45 includes, wherein the reaction comprises a position reaction component and a velocity reaction component.

In Example 47, the subject matter of Example 46 includes, wherein:

the position reaction is determined by:

$${U}_{R} = \frac{{r}_{R}}{{‖ {r}_{R} ‖}^{2}}$$

where
r_{R}=relative location vector between the drone camera and the obstacle; and

the velocity reaction is determined by:

U_{V}=e^{-λv}^{_{R}}^{·r}^{_{R}}

where
r_{R}=relative location vector between the drone camera and the obstacle:
v_{R}=relative velocity vector between the drone camera and the obstacle; and
λ=a constant that can be set based on a desired degree of responsiveness.

In Example 48, the subject matter of Examples 34-47 includes, wherein the medium further comprises instructions for the determining of the relative obstacle state by: estimating an obstacle state comprising a relative position and a relative velocity of the obstacle; and determining the relative obstacle state by determining a difference between the drone state and the obstacle state.

Example 49 is a computer-readable storage medium that stores instructions for execution by processing circuitry of a drone controller apparatus of a drone comprising a drone camera mounted on the drone, the instructions to configure the one or more processors to cause the wireless device to, at a first time when the drone is in flight: determine a drone state comprising a position and a velocity of the drone; determine a relative obstacle state comprising a relative position and a relative velocity of the drone with respect to an obstacle; determine a reaction to avoid the obstacle based on the relative obstacle state; and apply a signal related to the reaction to one or more actuator control inputs of the drone that modifies a drone path existing at the first time to avoid the obstacle.

Example 50 is drone controller logic, at least partially comprising hardware logic, and comprising: means for determining a drone state comprising a position and a velocity of the drone; means for determining a relative obstacle state comprising a relative position and a relative velocity of the drone with respect to an obstacle; means for determining a reaction to avoid the obstacle based on the relative obstacle state; and means for applying a signal related to the reaction to one or more actuator control inputs of the drone that modifies a drone path existing at a first time when the drone is in flight to avoid the obstacle.

In Example 51, the subject matter of Example 50 includes, means for defining an obstacle boundary as a geofence associated with the obstacle that utilizes information collected at the first time.

In Example 52, the subject matter of Example 51 includes, wherein the obstacle is at least one of: a space outside of a field-of-view (FOV) of an operator of the drone; a space of and over an obstacle object; a space within an FOV of an other drone; a space proximate to an object; and a first space proximate to an object and a second space away from the object that leaves a gap between the first and second space.

In Example 53, the subject matter of Example 52 includes, means for determining the space outside of the drone operator FOV with: means for determining a conical space representing the drone operator FOY based on location information of the drone operator and a predefined subtended angle of the conical space from a viewing line.

In Example 54, the subject matter of Example 53 includes, means for determining the viewing line as a line originating from the drone operator location and ending with a location of the drone.

In Example 55, the subject matter of Examples 53-54 includes, means for determining the viewing line as a line along a viewing direction of the drone operator.

In Example 56, the subject matter of Examples 52-55 includes, means for determining the space outside of the drone operator FOV with: means for determining a conical space representing the drone operator FOV based on location information of the drone operator and a predefined subtended angle of the conical space from a line originating from the drone operator location and ending with a location of the drone.

In Example 57, the subject matter of Examples 52-56 includes, wherein the means for determining the space of and over the obstacle object is performed by means for determining a cylindrical space centered on a location of the obstacle person, wherein the cylindrical space has a predefined radius and extends perpendicular to a ground plane.

In Example 58, the subject matter of Examples 52-57 includes, wherein the means for determining of the space within the other drone FOV is performed by means for determining the space using state information of the other drone.

In Example 59, the subject matter of Example 58 includes, wherein the other drone state information is received from the other drone.

In Example 60, the subject matter of Examples 58-59 includes, wherein the other drone state information is received from a source other than the drone and the other drone.

In Example 61, the subject matter of Examples 58-60 includes, wherein the other drone state information is determined from imaging information taken by a drone camera.

In Example 62, the subject matter of Examples 50-61 includes, wherein the reaction comprises a position reaction component and a velocity reaction component.

In Example 63, the subject matter of Example 62 includes, wherein:

the position reaction is determined by:

$${U}_{R} = \frac{{r}_{R}}{{‖ {r}_{R} ‖}^{2}}$$

where
r_{R}=relative location vector between the drone camera and the obstacle; and

the velocity reaction is determined by:

U_{V}=e^{-λv}^{_{R}}^{·r}^{_{R}}

where
r_{R}=relative location vector between the drone camera and the obstacle;
v_{R}=relative velocity vector between the drone camera and the obstacle; and
λ=a constant that can be set based on a desired degree of responsiveness.

In Example 64, the subject matter of Examples 50-63 includes, wherein the means for determining the relative obstacle state comprises: means for estimating an obstacle state comprising a relative position and a relative velocity of the obstacle; and means for determining the relative obstacle state by determining a difference between the drone state and the obstacle state.

In Example 65, the subject matter of Examples 50-64 includes, means for capturing an image mounted on a drone; and memory means coupled to the drone controller logic and the drone camera.

Example 66 is a drone controller apparatus of a drone comprising a drone camera mounted on the drone, the apparatus comprising, at a first time when the drone is in flight: means for determining a drone state comprising a position and a velocity of the drone; means for determining a relative obstacle state comprising a relative position and a relative velocity of the drone with respect to an obstacle; means for determining a reaction to avoid the obstacle based on the relative obstacle state; and means for applying a signal related to the reaction to one or more actuator control inputs of the drone that modifies a drone path existing at the first time to avoid the obstacle.

Example 67 is a computer program product comprising one or more computer readable storage media comprising computer-executable instructions operable to, when executed by processing circuitry of a device, cause the device to perform any of the methods of Examples 18-33.

Example 68 is a system comprising means to perform any of the methods of Examples 18-33.

Example 69 is a system perform any of the operations of Examples 1-66.

Example 70 is a method to perform any of the operations of Examples 1-66.

Example 71 is at least one machine-readable medium including instructions that, when executed by processing circuitry, cause the processing circuitry to perform operations to implement of any of Examples 1-66.

Example 72 is an apparatus comprising means to implement of any of Examples 1-66.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more,” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1-25. (canceled)

26. Drone controller logic at least partially comprising hardware logic to:
determine or receive a drone state comprising a position and a velocity of the drone;
determine or receive a relative obstacle state, including a relative position and a relative velocity of the drone with respect to an obstacle;
determine a reaction to avoid the obstacle based on the relative obstacle state; and
apply a signal related to the reaction to one or more actuator control inputs of the drone that modifies a drone path existing at a first time when the drone is in flight to avoid the obstacle.

27. The drone controller logic of claim 26, wherein the controller logic is further to define an obstacle boundary as a geofence associated with the obstacle that utilizes information collected at the first time.

28. The drone controller logic of claim 27, wherein the obstacle is at least one of:
a space outside of a field-of-view (FOV) of an operator of the drone;
a space of and over an obstacle object;
a space within an FOV of an other drone;
a space proximate to an object; and
a first space proximate to an object and a second space away from the object that leaves a gap between the first and second space.

29. The drone controller logic of claim 28, wherein the controller logic is further to determine the space outside of the drone operator FOV by being operable to:
determine a conical space representing the drone operator FOV based on location information of the drone operator and a predefined subtended angle of the conical space from a viewing line.

30. The drone controller logic of claim 29, wherein the controller logic is further to determine the viewing line as a line originating from the drone operator location and ending with a location of the drone.

31. The drone controller logic of claim 29, wherein the controller logic is further to determine the viewing line as a line along a viewing direction of the drone operator.

32. The drone controller logic of claim 28, wherein the controller logic is further to determine the space outside of the drone operator FOV by being operable to:
determine a conical space representing the drone operator FOV based on location information of the drone operator and a predefined subtended angle of the conical space from a line originating from the drone operator location and ending with a location of the drone.

33. The drone controller logic of claim 28, wherein the controller logic is further to determine the space of and over the obstacle object by being operable to determine a cylindrical space centered on a location of the obstacle person, wherein the cylindrical space has a predefined radius and extends perpendicular to a ground plane.

34. The drone controller logic of claim 28, wherein the controller logic is further to determine of the space within the other drone FOV by being operable to determine the space using state information of the other drone.

35. The drone controller logic of claim 34, wherein the other drone state information is information received from the other drone.

36. The drone controller logic of claim 34, wherein the other drone state information is information received from a source other than the drone and the other drone.

37. The drone controller logic of claim 34, wherein the controller logic is further to determine the other drone state information from imaging information taken by a drone camera.

38. The drone controller logic of claim 26, wherein the reaction comprises a position reaction component and a velocity reaction component.

39. The drone controller logic of claim 38, wherein:
the position reaction is determined by:
$${U}_{R} = \frac{{r}_{R}}{{‖ {r}_{R} ‖}^{2}}$$
where
r_{R}=relative location vector between the drone camera and the obstacle; and
the velocity reaction is determined by:
U_{V}=e^{-λv}^{_{R}}^{·r}^{_{R}}
where
r_{R}=relative location vector between the drone camera and the obstacle;
v_{R}=relative velocity vector between the drone camera and the obstacle; and
λ=a constant that can be set based on a desired degree of responsiveness.

40. The drone controller logic of claim 26, wherein the controller logic is further to determine the relative obstacle state by being operable to:
estimate an obstacle state comprising a relative position and a relative velocity of the obstacle; and
determine the relative obstacle state by determining a difference between the drone state and the obstacle state.

41. A method for operating drone controller logic that at least partially comprises hardware logic, the method comprising:
determining a drone state comprising a position and a velocity of the drone;
determining a relative obstacle state comprising a relative position and a relative velocity of the drone with respect to an obstacle;
determining a reaction to avoid the obstacle based on the relative obstacle state; and
applying a signal related to the reaction to one or more actuator control inputs of the drone that modifies a drone path existing at a first time when the drone is in flight to avoid the obstacle.

42. The method of claim 41, further comprising defining an obstacle boundary as a geofence associated with the obstacle that utilizes information collected.

43. The method of claim 42, wherein the obstacle is at least one of:
a space outside of a field-of-view (FOV) of an operator of the drone;
a space of and over an obstacle object;
a space within an FOV of an other drone;
a space proximate to an object; and
a first space proximate to an object and a second space away from the object that leaves a gap between the first and second space.

44. The method of claim 41, wherein the reaction comprises a position reaction component and a velocity reaction component.

45. The method of claim 44, wherein:
the position reaction is determined by:
$${U}_{R} = \frac{{r}_{R}}{{‖ {r}_{R} ‖}^{2}}$$
where
r_{R}=relative location vector between the drone camera and the obstacle; and
the velocity reaction is determined by:
V_{V}=e^{-λv}^{_{R}}^{·r}^{_{R}}
where
r_{R}=relative location vector between the drone camera and the obstacle;
v_{R}=relative velocity vector between the drone camera and the obstacle; and
λ=a constant that can be set based on a desired degree of responsiveness.

46. A non-transitory computer-readable storage medium that stores instructions for execution by drone controller logic that at least partially comprises hardware logic, the instructions to configure the drone controller logic to cause the wireless device to:
determine a drone state comprising a position and a velocity of the drone;
determine a relative obstacle state comprising a relative position and a relative velocity of the drone with respect to an obstacle;
determine a reaction to avoid the obstacle based on the relative obstacle state; and
apply a signal related to the reaction to one or more actuator control inputs of the drone that modifies a drone path existing at a first time when the drone is in flight to avoid the obstacle.

47. The computer-readable storage medium of claim 46, further comprising instructions for defining an obstacle boundary as a geofence associated with the obstacle that utilizes information collected at the first time.

48. The computer-readable storage medium of claim 47, wherein the obstacle is at least one of:
a space outside of a field-of-view (FOV) of an operator of the drone;
a space of and over an obstacle object;
a space within an FOV of an other drone;
a space proximate to an object; and
a first space proximate to an object and a second space away from the object that leaves a gap between the first and second space.

49. The computer-readable storage medium of claim 48, further comprising instructions for determining the space outside of the drone operator FOV by:
determining a conical space representing the drone operator FOV based on location information of the drone operator and a predefined subtended angle of the conical space from a viewing line.

50. The computer-readable storage medium of claim 49, further comprising instructions for determining the viewing line as a line originating from the drone operator location and ending with a location of the drone.
